(19) United States
(12) Patent Application Publication
(10) Pub. No.: US 2026/0288079 A1
(43) Pub. Date: Sep. 24, 2026

(54) Method and System for Registration of Watches

(71) Applicant: U-NICA Solutions AG, Landquart (CH)

(72) Inventors: Frank Kaminsky, Stein am Rhein (CH); Alexander Rüegg, Baden (CH)

(21) Appl. No.: 19/469,439

(22) PCT Filed: Mar. 22, 2024
(86) PCT No.: PCT/EP2024/057875

§ 371 Date: Sep. 26, 2025

(30) Foreign Application Priority Data
Mar. 27, 2023 (CH) CH000337/2023

(51) Int. Cl. G04D 7/00; G06V 10/26; G06V 20/62; G06V 20/80

(52) U.S. Cl. CPC G04D 7/00; G06V 10/273; G06V 20/62; G06V 20/80

(57) ABSTRACT

The disclosure relates to a computer-implemented method and a computerized registration system for registration of a watch component. The method includes receiving in a computerized registration system, from a registration camera, an image of a watch component (W, W′) including a serial number, extracting the serial number of the watch component (W, W′), extracting micro features of the watch component (W, W′), generating a watch component registration code by processing the micro features using a one-way function, and storing the serial number in association with the watch component registration code.

### CROSS REFERENCE TO RELATED APPLICATIONS

This application is the United States national phase of International Patent Application No. PCT/EP2024/057875 filed Mar. 22, 2024, and claims priority to Switzerland Patent Application No. CH000337/2023 filed Mar. 27, 2023, the disclosures of which are hereby incorporated by reference in their entireties.

### BACKGROUND OF THE INVENTION

### Field of the Invention

The present disclosure relates to a method and system for registration of watches, in particular entire watches, watch parts, and/or watch components.

### Description of Related Art

The field of watches is characterized by unique components and exceptional craftsmanship, as well as by the association of several distinctive parts such as the movement, the bracelet, the case and the dial, which are all manufactured to high standards of quality and reliability.

This makes watches an object of value and a target of counterfeiting. It is not only the external appearance that is affected by counterfeits and imitations, but also individual components of the movement, including potentially the use of similar or identical materials and/or manufacturing procedures. It can be at first glance difficult to assess the authenticity of a watch or of individual components by simple examination. This makes it necessary to find a way of authenticating a watch and/or one or some of its parts and/or components quickly and reliably. It is not sufficient to provide watch components with, for example, a special finish, blued screws, characteristic design elements, or special markings such as micro prints, micro QR codes, or similar features. Higher-value security features commonly used in mechanical engineering, such as microchips, cannot be sufficiently miniaturized or lead to quality defects or visual depreciation, and include electronic circuits or parts which may not be adequate for mechanical watches and/or high-end watches.

Watches, including their parts such as movement, bracelet, case, dial, as well as other parts and their components, may have serial numbers, but these do not in themselves enable authentication. Embossing of faked serial numbers can possibly be verified by comparing it with database entries, but this is not guarantee of authenticity. Furthermore, this type of authentication is time-consuming and can only be carried out by authorized parties, such as the manufacturer itself. There is therefore a need for fast and reliable procedures which, if possible, can be carried out using simple, if not ubiquitous, methods. The inventive solution showcased here represents such a procedure.

### SUMMARY OF THE INVENTION

It is an object of the disclosure and embodiments disclosed herein to provide methods and systems for registration of watches, in particular entire watches, watch parts, watch components and/or articles related to watches. The aforementioned are all designated herein as “watch components” for the sake of simplicity.

In particular, it is an object of the disclosure and embodiments disclosed herein to provide a computer-implemented method and a computerized system for registration of a watch part which does not have at least some disadvantages of the prior art, for example in that it does not require any adaptation of existing watch components. Other objects of the disclosure include methods and systems which are additionally capable of authenticating watch components and which do not have the typical disadvantages of the prior art of altering the external appearance of watch components or making the authentication process cumbersome in terms of sophisticated analytical equipment or time consuming process.

According to the present disclosure, a computer-implemented method for registration of a watch components comprises receiving, in a computerized registration system, from a registration camera, an image of a watch component, the image including a serial number of the watch component. The method comprises extracting, in the computerized registration system, the serial number of the watch component from the image, for example using optical character recognition. The method comprises extracting, in the computerized registration system, micro features of the watch component from the image. The method comprises generating, in the computerized registration system, a watch component registration code by processing the micro features, for example, using a one-way function. The method comprises storing the serial number in association with the watch component registration code.

In an embodiment, the method further comprises generating, in the computerized registration system, a watch component registration message comprising the serial number and the watch component registration code. The method comprises digitally securing, by the computerized registration system, the watch component registration message. Digitally securing may include, in the watch component registration message, a digital signature generated in the computerized registration system. Additionally or alternatively, the watch component registration message is digitally secured by way of encrypting contents of the watch component registration message using a secret key of the computerized registration system. Storing the serial number in association with the watch component registration code comprises transmitting, from the computerized registration system to a watch component data storage system, the optionally digitally secured watch component registration message. The digitally secured watch component registration message is received in the watch component storage system. The watch component data storage system determines whether the digitally secured watch component registration message is authentic by validating the digital signature and additionally or alternatively by successful decryption of the watch component registration message. The watch component data storage system stores the serial number in association with the watch component registration code dependent on affirmative authentication of the watch component registration message.

In an embodiment, the method further comprises receiving, in a computerized verification system, from a verification camera device, a verification image of the watch component, the verification image including the serial number of the watch component. The method comprises extracting, in the computerized verification system, the serial number of the watch component from the verification image, for example using optical character recognition. The method comprises extracting, in the computerized verification system, micro features of the watch component, from the verification image. The method comprises generating, in the computerized verification system, a watch component verification code by processing the micro features using the one-way function. The method comprises authenticating the watch component, in the computerized verification system, if the watch component verification code matches the stored watch component registration code for the watch component with the serial number.

In an embodiment, authenticating the watch component comprises calculating, in the computerized verification system, a correspondence value using a correspondence function. The correspondence value is indicative of a degree of correspondence between the watch component verification code and the watch component registration code. The method comprises authenticating, in the computerized verification system, the watch component if the correspondence value satisfies a pre-defined correspondence threshold. If the correspondence value does not satisfy the pre-defined correspondence threshold, the watch component is not authenticated.

In an embodiment, authenticating the watch component further comprises analyzing, in the computerized verification system, using image analysis, the verification image to determine a level of wear of the watch component. The method comprises modifying, in the computerized verification system, the pre-defined correspondence threshold depending on the level of wear of the watch component.

In an embodiment, calculating the correspondence value using the correspondence function uses a time difference between a time-point that the watch component registration code was generated and a time-point that the watch component verification code was generated.

In an embodiment, the method comprises analyzing, in the computerized verification system, using image analysis, the verification image to determine a level of wear of the watch component. The method comprises determining, in the computerized verification system, whether the level of wear exceeds a pre-defined wear threshold. The method comprises generating, in the computerized verification system, a status change message including the serial number of the watch component and an updated status of the watch component, the updated status indicating that the watch component has been flagged for servicing or exchange or repair, upon the level of wear exceeding the pre-defined wear threshold.

In an embodiment, the method comprises generating a cropped image of the watch component which includes the serial number and a pre-defined margin around a bounding box of the serial number. The method comprises extracting the micro features of the watch component from the cropped image.

In an embodiment, the micro features of the watch component include inhomogeneities of the watch component and/or features caused by irreproducible randomness in a manufacturing process of the watch component.

In an embodiment, the method further comprises receiving, in the watch component data storage system, the watch component verification code and the serial number. The method comprises storing, in the watch component data storage system, the watch component verification code in association with the serial number. Optionally, the watch component registration code is be updated using the watch component verification code.

In an embodiment, the method further includes receiving, in the computerized verification system, metadata from the verification camera device, the metadata including hardware configuration information of the verification camera device. The hardware configuration information includes, for example, information related to the hardware configuration of the camera, such as optical characteristics and/or imaging characteristics. The hardware configuration information may also include information related to other aspects of the verification camera device. The metadata may include software configuration information of the verification camera device. The metadata may include user information of a user of the verification camera device. The metadata may include contact information of the verification camera device, diagnostics data of the verification camera device, a current time-stamp, location information of the verification camera device, and/or information related to one or more previous watch components the verification camera device has imaged. Preferably, the metadata uniquely identifies the verification camera device.

In an embodiment, the method comprises recording, in the computerized verification system, a status log associated with the watch component, the status log including a plurality of log entries, each entry comprising the watch component verification code and optionally the metadata from the verifying device. The log entry may include the degree of correspondence associated with the watch component verification code.

In an embodiment, the method comprises transmitting, from a computerized authorization system to the watch component data storage system, a status change message including the serial number of the watch component and an updated status of the watch component, the updated status including, for example, the following watch component statuses: registered, in stock, to be serviced, to be repaired, to be exchanged, to be replaced, to be updated, to be upgraded, to be destroyed, retired, destroyed, etc. Other watch component statuses may be defined according to particular implementation requirements. The method includes updating, in the watch component data storage system, a status of the watch component according to the updated status. In an embodiment, the status change message includes a plurality of a digital signatures from a plurality of authorization entities, and updating the status of the watch component is dependent on the computerized authorization system affirmatively verifying the confirmations. The plurality of authorization entities may be selected from a larger pool of authorization entities. The selection may be a random selection, for example generated by the computerized authorization system.

In addition to a method for registration of a watch component, the present disclosure relates to a computerized registration system for registration of a watch component. The computerized registration system comprises a processing unit configured to receive, from a registration camera, an image of a watch component, the image including a serial number of the watch component. The processing unit is configured to extract the serial number of the watch component from the image, for example using optical character recognition. The processing unit is configured to extract micro features of the watch component from the image. The processing unit is configured to generate a watch component registration code by processing the micro features using a one-way function. The processing unit is configured to store the watch component registration code in association with the serial number of the watch component.

In an embodiment, the processing unit of the computerized registration system is configured to perform one or more of the methods, or method steps, as described herein.

In addition to the computerized registration system for registration of a watch component, the present disclosure also relates to a computerized verification system for verification of a watch component. The computerized verification system includes a processing unit configured to receive, from a verification camera device, a verification image of a watch component, the verification image including a serial number of the watch component. The processing unit is configured to extract the serial number of the watch component from the verification image, for example using optical character recognition. The processing unit is configured to extract micro features of the watch component from the verification image. The processing unit is configured to generate a watch component verification code by processing the micro features using a one-way function. The processing unit is configured to authenticate the watch component, if the watch component verification code matches a watch component registration code, stored in a watch component data storage system for the serial number of the watch component.

In addition to a method for registration of a watch component and a computerized system for registration of a watch component, the present disclosure also relates to a computer program product for registration of a watch component. The computer program product comprises computer program code configured to control a processing unit such that the processing unit performs a number of steps as described herein. The steps include receiving, from a registration camera, an image of a watch component, the image including a serial number of the watch component. The steps include extracting the serial number of the watch component from the image, for example using optical character recognition. The steps include extracting micro features of the watch component from the image. The steps include generating a watch component registration code by processing the micro features using a one-way function. The steps include storing the watch component registration code in association with the serial number of the watch component.

In an embodiment, the computer program product for registration of a watch component is implemented as a non-transitory computer readable medium, having stored thereon the computer program code configured to direct the processing unit to perform one or more of the methods or parts thereof as described herein.

The present disclosure also relates to a computer program product for verification of a watch component comprising computer program code configured to control a processing unit such that the processing unit performs a number of steps as described herein. The steps include receiving, from a verification camera device, a verification image of a watch component, the verification image including a serial number of the watch component. The steps include extracting the serial number of the watch component from the verification image, using for example optical character recognition. The steps include extracting micro features of the watch component from the verification image. The steps include generating a watch component verification code by processing the micro features using the one-way function. The steps include authenticating the watch component, if the watch component verification code matches a watch component registration code, stored in a watch component data storage system for the serial number of the watch component.

In an embodiment, the computer program product for verification of a watch component is implemented as a non-transitory computer readable medium, having stored thereon the computer program code configured to direct the processing unit to perform one or more of the methods or parts thereof as described herein.

### BRIEF DESCRIPTION OF THE DRAWINGS

The herein described disclosure will be more fully understood from the detailed description given herein below and the accompanying drawings, which should not be considered limiting to the invention described in the appended claims. The drawings in which:

FIG. 1 shows a diagram showing schematically a system architecture including a computerized registration system and a computerized verification system according to an embodiment of the invention;

FIG. 2 shows a block diagram illustrating schematically a watch component registration system;

FIG. 3 shows a block diagram illustrating schematically a watch component verification system;

FIG. 4 shows a flow diagram illustrating a method for registration of a watch component;

FIG. 5 shows a flow diagram illustrating a method for verification of a watch component registration code;

FIG. 6 shows a flow diagram illustrating a method for storage of a watch component registration code;

FIG. 7 shows a flow diagram illustrating a method related to determining a level of wear of a watch component; and

FIG. 8 shows a flow diagram illustrating a method for updating a status of a watch component.

### DESCRIPTION OF THE INVENTION

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

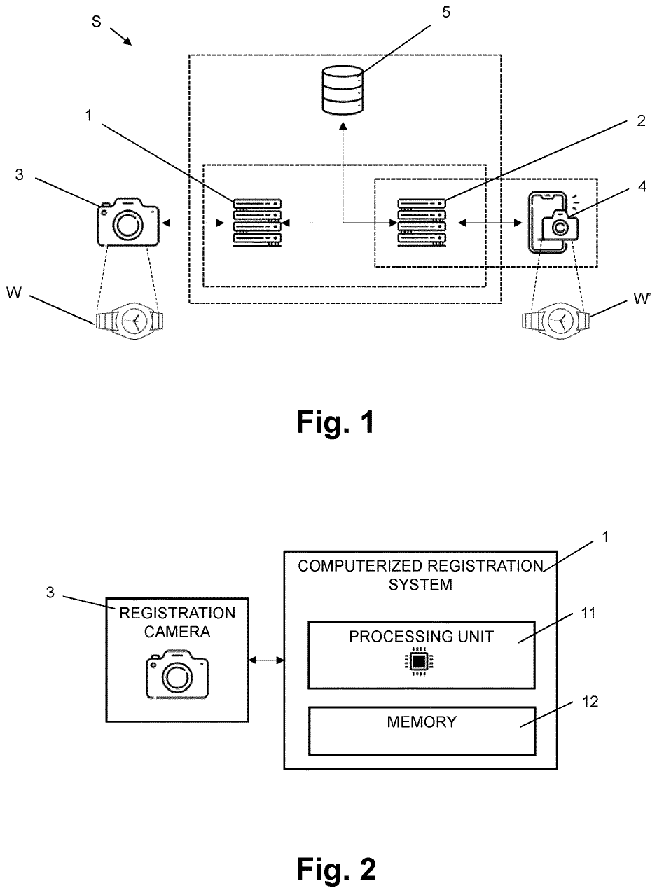

FIG. 1 shows a diagram showing schematically a system architecture of an electronic system S according to an embodiment of the invention including a computerized registration system 1, a computerized verification system 2, and a watch component data storage system 5. The various (sub) systems, devices, parts and/or components of the electronic system S are connected to each other, either directly or indirectly. Depending on the particular implementation of the invention, the one or more (sub) systems, devices, parts and/or components of the electronic system S may be integrated into one or more common devices, share components and/or resources, as illustrated in FIG. 1 and as explained below.

The connections are configured for data communication and may include a wired and/or wireless connection. The connections may involve intermediary networks, in particular communication networks such as LANS, WLANs, VPNs, mobile radio networks, and/or the Internet.

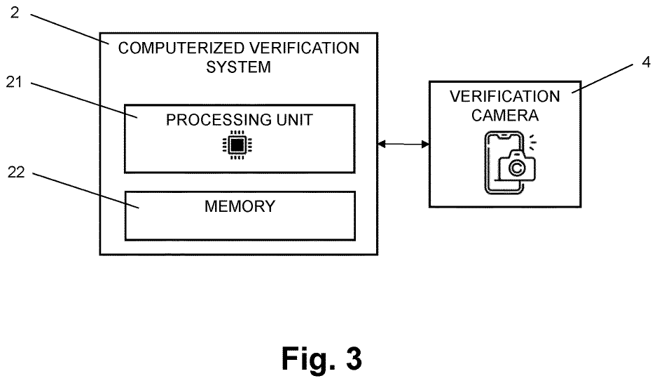

The computerized registration system 1 is described in more detail with reference to FIG. 2. The computerized verification system 2 is described in more detail with reference to FIG. 3.

In an embodiment, data communication within the electronic system S, in particular between the computerized registration system 1 and the watch component data storage system 5, and between the computerized verification system 2 and the watch component data storage system 5, is secured. The data communication is secured to ensure the integrity and authenticity of data communicated and may include the use of digital signatures, digital certificates, encrypted communications, obfuscated communications, and/or (virtual) private networks. Additionally, dedicated private communication infrastructure may be used including, for example, a dedicated line (i.e. a communications cable between the computerized registration system 1 and the watch component storage system 5, and between the computerized verification system 2 and the watch component data storage system 5, which communications cable is not used or shared by any other entities).

The computerized registration system 1 is connected to a registration camera 3. The connection between the registration camera 3 and the computerized registration system 1 is, for example, a wired and/or wireless connection for data communication.

The registration camera 3 is configured to record one or more images of a watch component W, as is explained in more detail with reference to FIG. 2. In the present FIG. 1, the watch component is designated with the reference sign W during imaging by the registration camera 3. During imaging by the verification camera device 4, the watch component is designated with the reference sign W′. However, the watch component W, W′ is one and the same watch component.

Under the designation of “watch components”, we understand for the sake of simplicity watches, watch parts, watch components, as well as articles related to watches. A watch is a time instrument designed to be worn and to operate in all positions, as defined by ISO committee TC 114. A watch comprises several watch parts, such as the movement, the case, the bracelet and the dial and hands. Usually, a watch part consists in an assembly of several watch components. For example, a watch bracelet is an assembly of bracelet links, a clasp and other components. For example, a dial is an assembly of a dial plate, indexes, means of fixation and other components. For example, a movement is an assembly of a mainplate, bar and bridges, springs such as a balance spring and a barrel spring, a winding rotor, wheels and other components. Watch articles are articles related to watches, such as a warranty certificate, a warranty seal, a watch box, watch accessories such as cufflinks, and the like, which can be sold with the watch.

A watch component may have several surface elements that may carry micro features and a serial number. The one or more images of the watch component W include at least one image of a surface element of the watch component including a serial number of the watch component W. The serial number of a watch component is a string of numbers and/or letters which uniquely identifies the watch component W. Additionally, the serial number of a watch component W may include a checksum which may be used for the purpose of detecting errors in inscribing the watch component W, in recording and analyzing the serial number of the watch component W, and/or after transmission of the serial number of the watch component W. The checksum may therefore be used to verify the integrity of the serial number. However, the checksum cannot be used to verify authenticity of the serial number.

Depending on the particular watch component W, the serial number may be inscribed on a visible surface element of the surface component, that is, the serial number may be directly viewed by an observer or a camera without needing disassembly. For example, the serial number of the watch and/or of the watch case can be inscribed under one of the lugs of the watch case. If the case features a transparent back, the serial number of the movement could be inscribed on a visible surface of the movement mainplate, and be visible through the transparent back. Alternatively or complementarily, the serial number may be inscribed on a non-visible surface element of the watch component, that is, the serial number can be viewed only after a disassembly step. For example, the serial number of the watch and/or watch case can be inscribed between the lugs of the case and hidden by the last link of the bracelet, and be visible only after disassembly of the bracelet from the case. For example, the serial number of the dial can be inscribed on the back surface of the dial plate, which is non visible and can be accessed only by disassembly of the dial from the movement. In some cases, the serial number may be inscribed on a watch component W more than once.

The housing or case of a watch, for example, may have the serial number inscribed in two places that are not visible on the finished watch. Each of the serial numbers may be inscribed using different sizes or fonts for the characters that constitutes serial number.

Parts of the watch that have no serial number, such as screws, are not referred to as watch components W in the sense of the inventive solution.

In addition to the serial numbers, watch components may contain other security features to pre-vent counterfeiting or forgery. The security features include, for example, imprints of nano-bar-codes, tagged materials or unique design features, special geometries, special surface finishes, etc.

The process of manufacture of the watch component W results in irreproducible irregularities between two watch components made by the same process, even if their dimensions and properties are very similar or nearly identical. These irreproducible irregularities are the result, for example, of manufacturing the watch components. Manufacturing processes to produce watch components include technologies such as machining, cutting, grinding, turning and/or stamping. Both subtractive and additive manufacturing technologies may be used. Furthermore, the watch components are usually finished with processes such as tribofinishing, polishing, burnishing and the like to impart a given surface finish and/or surface roughness, for aesthetical and/or functional reasons. The processes listed above, as well as other processes, result in irreproducible irregularities and therefore distinctive micro features.

These irreproducible irregularities result in micro features of watch components are differing from one component to another. The irreproducible irregularities are visible, for example as sanding marks, cutting angles, differences in texture, etc. These deviations may be defined with respect to other watch components of the same type, or deviations with respect to a model or watch component blueprint, for example as defined in a digital model or in one or more special tools or a parametrization of a tool, such as a laser cutting or laser engraving device. In summary, it is practically impossible to manufacture watch components which are identical to each other, in particular which are determined to be identical by comparing images (such as high-resolution and/or high magnification images and/or images acquired with a camera and/or a smartphone) of two watch components W.

Therefore, each particular watch component W has, beyond a unique serial number, also unique micro features around and/or in the vicinity of the serial number and/or intersecting the serial number, which further uniquely identify the particular watch component W and which cannot be reproduced. In particular, these unique micro features may be at least partially the result of a cutting and/or engraving process, in particular a cutting and/or engraving process which includes cutting and/or engraving of the serial number.

The computerized registration system 1 is connected to a watch component data storage system 5. The watch component data storage system 5 is implemented, for example, as a database stored in non-transitory memory. The database may be a relational or non-relational database, a file system, a key-value store, or another kind of document or file database.

The database may be implemented as a cloud database configured to run in a public, private or hybrid cloud computing environment. The database may be implemented on a private server. The database may be implemented as a decentralized database configured to store information across a network of distributed servers, for example for purposes of redundancy or security.

In an embodiment, the computerized registration system 1 includes the watch component data storage system 5.

The watch component data storage system 5 is configured to store information related to and/or associated with watch components, in particular with watch components of a particular series of watch models. For a particular watch component W, W′, the information may include the watch component serial number, the watch component type, the watch component registration code, a level of wear, a watch component status, and/or a time-point at which the watch component entered the point of assembly or the point of final control and certification or the point of shipping or the point of sale or the point of after-sales servicing. The information may further include a status log associated with the watch component, the status log including a plurality of log entries. The log entries may relate to events which concern the watch component W. For example, a log entry may include that the watch component has been registered and may include the watch component registration code. A log entry may relate to a verification event and include the associated watch component verification code, a correspondence value, and/or metadata related to the verification event. A log entry may relate to a change of status of the watch component. The watch component statuses include, for example, registered, in stock, to be serviced, to be repaired, to be exchanged, to be replaced, to be updated, to be upgraded, to be destroyed, retired, destroyed, or other potential action, etc. The log entries may also relate to the serial numbers of the other components comprising the watch part and/or watch of which said component is part of. For example, for a watch case, the log entries may relate to the serial number of the movement, dial, and/or bracelet assembled with said case, as well as to the serial number of the watch box and/or warranty certificate associated with it. The log entries may also record different versions of associations of watch components forming a watch part and/or an entire watch, for example when a watch component has been exchanged during servicing.

The computerized verification system 2 is connected to the computerized registration system 1 and/or the watch component data storage system 5. For example, the computerized registration system 2 is connected to the computerized registration system 1 which itself is connected to the watch component storage system 5. Additionally or alternatively, the computerized registration system 2 is connected to the watch component data storage system 5. The computerized verification system 2 is additionally connected to a verification camera device 4. The connection is configured for data communication between the computerized verification system 2 and the verification camera device 4.

In an embodiment, the verification camera device 4 is integrated with the computerized verification system 2.

The verification camera device 4 is configured to record one or more images of the watch component W′. As explained above, the watch component W′ corresponds to the watch component W at a later time-point. The verification camera device 4 is explained below in more detail.

FIG. 2 shows a block diagram illustrating schematically a computerized registration system 1. The registration system is, in an embodiment, part of the electronic system S of FIG. 1. The computerized registration system 1 is connected to a registration camera 3 and is further connected to a watch component data storage system 5 (not shown). The computerized registration system 1 may be implemented, for example, as a server computer. The server computer may be hosted or virtualized on a cloud computing platform. The computerized registration system 1 comprises a processing unit 11 and a memory 12. The computerized registration system 1 further includes modules for data communication, in particular with the registration camera 3, the watch component data storage system 5 and/or the computerized verification system 2. The computerized registration system 1 may further comprise additional necessary or optional modules, for example human machine interface (HMI) modules for receiving data input and/or for providing data output. The processing unit 11 comprises one or more electronic chips, for example one or more integrated circuits, microcontrollers, microprocessors, application specific circuits (ASICs), or the like. The memory 12 comprises volatile (non-persistent) and/or non-volatile (persistent) memory modules. For example, the memory 12 is implemented using solid state memory (e.g. flash memory). The processing unit 11 is configured to execute out one or more steps and/or functions as described herein. For example, the processing unit 11 is configured to execute one or more steps and/or functions as stored in the memory 12. The steps and/or functions are stored, for example, in the memory 12 as program code (e.g., as part of the firmware, the operating system, runtime environments, software applications, and/or software libraries). Other steps and/or functions may be carried out by specifically arranged circuitry in the processing unit 11.

Depending on the embodiment, the processing unit 11 and the memory 12 may be integrated into a single electronic chip, for example in the form of a System on a Chip (SoC).

The registration camera 3 is configured to record one or more images of the watch component W (not shown). The registration camera 3 is arranged, for example, at a place of manufacture of the watch component W (e.g., at an industrial plant of the manufacturer) and/or at a place of assembly of the watch parts from watch components and/or at a place of assembly of the watch from watch parts and/or at a place of servicing (or repairing) the watch or watch parts or watch components. The registration camera 3 is preferably arranged along an assembly line at a manufacturing facility or assembly facility or control facility or servicing facility.

In an embodiment, a plurality of registration cameras 3 are arranged in a registration camera assembly configured to image a group of watch components W of the same type being separated into individual watch components W.

The registration camera 3 includes an image sensor including, for example, a CMOS or a CCD image sensor which include a photo sensor array. Preferably, the image sensor is configured to record in the wavelength range visible to the unaided human eye, e.g., from approximately 390 nm-750 nm. In particular embodiments, however, the image sensor may further be configured to record in the infrared wavelength range (for example, in the near infrared wavelength range of approximately 700 nm to 1700 nm) and/or in the ultra-violet wavelength range (e.g., including the near ultraviolet range including UV-A light of between 320 nm and 400 nm and/or UV-B light of between 280 nm and 320 nm).

The registration camera 3 further includes an optical assembly for imaging the watch component W. The optical assembly may include one or more lenses and/or mirrors.

The registration camera 3 may further include a lighting module for providing sufficient and/or correct illumination of the watch component W. The lighting module may include one or more lamps or flashes arranged to illuminate the watch component. Preferably, the lighting module is configured to provide a light level such that sharp image(s) of the watch component are obtained when imaging at high speed, for example with a shutter speed of less than 1/1000s. The lighting module is in particular configured to provide a light output of a similar color temperature to day-light.

In an embodiment, the registration camera 3 is configured to record an image of one surface element of the watch component and an image of another surface element of the watch component W in consecutive shots or simultaneously.

For example, the registration camera 3 is configured to record an image of both surfaces of the watch component W in that an image of a first surface of the watch component W is recorded, the watch component is then rotated and an image of a second surface element of the watch component W is recorded.

In another example, the registration camera 3 comprises two imaging sensors and is configured to record an image of a first surface element of the watch component W using a first imaging sensor and record an image of the second surface element of the watch component W using a second imaging sensor.

FIG. 3 shows a block diagram illustrating schematically a computerized verification system 2. The computerized verification system 2 may be integrated into the computerized registration system 1 as described above. In an embodiment, the computerized verification system 2 may be implemented in the same computer system as the computerized registration system 1. The computerized verification system 2 may be implemented, for example, as a server computer. The server computer may be hosted or virtualized on a cloud computing platform.

The computerized verification system 2 is connected to a verification camera device 4. The computerized verification system 2 is further connected to the watch component data storage system 5 and optionally to the computerized verification system 1.

The computerized verification system 2 comprises a processing unit 21 and a memory 22. The computerized verification system 1 further includes modules for data communication, in particular with the verification camera device 4, the watch component data storage system 5 and/or the computerized registration system 1. The computerized verification system 2 may further comprise additional necessary or optional modules, for example human machine interface (HMI) modules for receiving data input and/or for providing data output.

The processing unit 21 comprises one or more electronic chips, for example one or more integrated circuits, microcontrollers, microprocessors, application specific circuits (ASICs), or the like. The memory 22 comprises volatile (non-persistent) and/or non-volatile (persistent) memory modules. For example, the memory 12 is implemented using solid state memory (e.g. flash memory). The processing unit 21 is configured to execute out one or more steps and/or functions as described herein. For example, the processing unit 21 is configured to execute one or more steps and/or functions as stored in the memory 22. The steps and/or functions are stored, for example, in the memory 22 as program code (e.g., as part of the firmware, 5 the operating system, runtime environments, software applications, and/or software libraries). Other steps and/or functions may be carried out by specifically arranged circuitry in the processing unit 21.

Depending on the embodiment, the processing unit 21 and the memory 22 are integrated into a single electronic chip, for example in the form of a System on a Chip (SoC).

The verification camera device 4 is configured to record at least one image of a watch component W′ (not shown). The verification camera device 4 includes a camera, comprising, for example, an imaging sensor and an optical system. The camera may further include a lighting module, such as a flash or light. The verification camera device 4 further includes a communications module configured for data communication with the computerized verification system 2. Depending on the embodiment, the verification camera device 4 includes a processing unit and memory (e.g., as described above with reference to the computerized registration system 1 and/or the computerized verification system 2).

In an embodiment, the verification camera device 4 is implemented as a mobile communication device, in particular a handheld portable communication device, such as a smart phone or tablet. The mobile communication device may comprise additional modules, including a battery, a human machine interface (including, for example, a touch screen), and/or a communications module. The communications module may comprise a mobile radio transceiver for data communication via a mobile radio network and a WiFi transceiver for data communication via a WLAN. The mobile communication device may run an operating system (such as iOS or Android). The mobile communication device may have installed thereon software applications (e.g., Apps downloaded from a cloud service such as Apple's App Store or Google's Play Store). The mobile communication device is typically operated by a user.

In an embodiment, the verification camera device 4 is implemented as a portable electronic device, for example as a watch component quality control device configured to check whether the tolerances of a certain watch component is within accepted limits. The portable electronic device may additionally or alternatively be implemented as a watch component authentication device configured to check, either automatically or through operation by a user, for example a type of watch component, whether the watch component is counterfeit or not, etc.

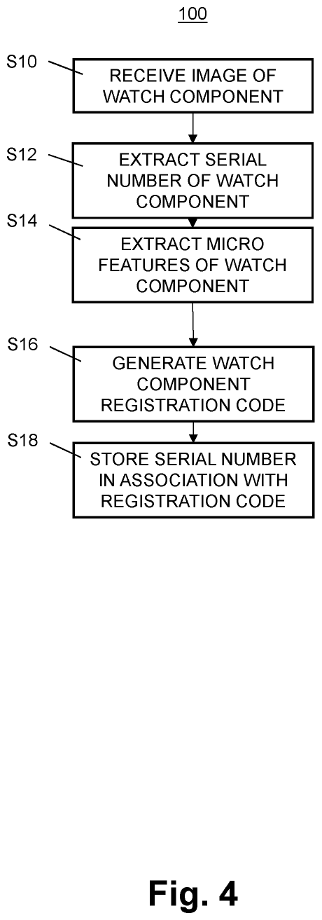

FIG. 4 shows a flow diagram illustrating a method 100 for registration of a watch component W. The method 100 may be performed in a facility which manufactures watch components, for example a facility for movement assembly. For example, the method 100 is performed immediately subsequent to manufacturing the watch components. Alternatively or additionally, the method 100 is performed immediately subsequent to assembly of the watch part. Alternatively or additionally, the method 100 is performed immediately subsequent to assembly of the watch. Alternatively or additionally, the method 100 is performed immediately subsequent to control or certification of the watch. Alternatively or additionally, the method 100 is performed immediately prior or subsequent to servicing of the watch or watch part or watch component. The method 100 may also be performed by an authorized entity tasked with processing, storing, distributing, handling, managing, checking, or otherwise interacting with new and/or used watches, for example a boutique owned by the manufacturer or a concessionaire for the watch brand, etc. The method 100 comprises a number of step S10-S18. These steps may be performed by the computerized registration system 1. The method 100 may additionally include optional preparatory steps, subsequent steps, or intermediary steps as described below. The time-point of registration may be designated as a time point to.

Preferably, the method 100 or at least some of the steps of the method 100 are performed in real-time, such that the steps may be performed continuously during manufacturing of the watch component W. In particular, steps S10-S16, which relate to receiving images of the watch component W up to generating a watch component registration message, are performed in real time. The storage of the watch component registration message may also be performed in real time, however at least some of the watch component registration messages may also be cached or otherwise buffered. What is meant by real time is that steps S10-S16 are performed within a defined time window, in particular within 0.1 s to 10 s, preferably within 1 to 5 seconds. Thereby, the computerized registration system 1 can keep up with modern robotic workstations which are capable of assembling certain watch components in less than one second.

In a preparatory step, the registration camera 3 records one or more images of the watch component. In particular, the registration camera 3 uses an image sensor to record at least one image of at least one surface element of the watch component. The registration camera 3 records at least one image of a surface of the watch component W including the serial number.

In an embodiment, the registration camera 3 preprocesses the image(s) of the watch component, for example by cropping the image(s) such that only a bounding box (e.g., a rectangular section) of the image(s) including the serial number and a defined border or margin remains. In an example where a given surface element of the watch component includes the serial number twice, the registration camera 3 may be configured to generate two cropped images of the watch component, a first cropped image including a first instance of the serial number and a second cropped image including a second instance of the serial number. The registration camera 3 transmits the one or more images to the computerized registration system 1.

In step S10, the computerized registration system 1 receives the one or more images of the watch component W from the registration camera 3. The computerized registration system 1 may authenticate the one or more images, for example using metadata of the one or more images and/or metadata derived by the registration camera 3 and/or the manufacturing process. The one or more images are authenticated to ensure that only images from legitimate sources (i.e. trusted and authorized registration cameras 3) are processed further by the computerized registration system 1.

In step S12, the computerized registration system 1 extracts the serial number from the one or more images. The computerized registration system 1 is configured to use optical character recognition (OCR) to extract the serial number.

As an alternative, it is possible to encode the serial number with a barcode or a QR-code or the like, with corresponding means to extract the serial number from an image. For the sake of simplicity, such means are also included in the term “optical character recognition (OCR)”.

In an embodiment, the computerized registration system 1 identifies a type of a watch component or is capable to assign it to a certain watch model using the one or more images. The watch component type includes the information about the watch model that may include this particular watch component and, if necessary, information about the material (e.g. steel, ceramic, gold, and others), type of movement, etc. of the watch model that it is assigned to.

In an embodiment, the computerized registration system 1 verifies the integrity of the extracted serial number, for example by computing a checksum of the serial number and comparing it with a check digit. Computing the checksum may include making use of the identified type of watch component. Additionally or alternatively, the computerized registration system 1 may verify the validity of the serial number by performing a look-up in a table or database, which table or database includes serial numbers of watch component which have been manufactured. In an embodiment, the database includes serial numbers of already sold items.

In step S14, the computerized registration system 1 extracts micro features of the watch component from the one or more images. The micro features are, as explained herein, irreproducible or unclonable features unique to the particular instance of the watch component, such that a second watch component, hypothetically even including the same serial number, would not have the same micro features. In a manner of speaking, the micro features provide a “fingerprint” of the watch component.

In an embodiment, the computerized registration system 1 crops the one or more images received from the registration camera 3, for example by cropping the image(s) such that only a bounding box (e.g., a rectangular section) of the image(s) including the serial number and a defined border remains. In an example where a given surface element of the watch component includes the serial number twice, the computerized registration system 1 may be configured to generate two cropped images of the watch component, a first cropped image including a first instance of the serial number and a second cropped image including a second instance of the serial number.

In an embodiment where the watch component has two copies of the serial number, the computerized registration system 1 is configured to extract micro features from within a bounding box surrounding a particular defined copy of the serial number. Alternatively, the computerized registration system 1 is configured to extract micro features from within two bounding boxes, each bounding box associated with a particular copy of the serial number.

In an embodiment, the micro features correspond to a plurality of landmarks. These landmarks are local regions in the images which may vary between watch components. The landmarks may be pre-defined or may be automatically identified by the computerized registration system.

In step S16, the computerized registration system 1 generates a watch component registration code using the micro features (and/or the one or more images) and a one-way function. Specifically, the one-way function receives the micro features and/or the one or more images as inputs and generates, as an output, the watch component registration code. The watch component registration code is, for example, an L-dimensional vector or an alphanumeric string.

In particular, the one-way function is configured such that the micro features are not reproducible using the watch component registration code. An additional important characteristic of the one-way function is that of locality, such that a small difference in the micro features is preserved in a relative distance (computed using a metric such as the Euclidean distance) in the output watch component registration code. The small difference in the micro features may be in that each micro feature is varied slightly, or that the set of micro features differs.

The one-way function is implemented, for example, using a locality-preserving hash function in which two sets of similar micro features produce watch component registration codes which are similar.

In an embodiment, the computerized registration system 1 is configured to extract the micro features and generate the watch component registration code according to the methods and techniques described in WO2009115611A2, which is hereby incorporated by reference in its entirety. In step S18, the computerized registration system 1 is configured to store the serial number in association with the watch component registration code. Optionally, metadata of the registration system 1 and/or of the registration camera 3 is stored in association with the serial number. Optionally, a timestamp of a registration time-point to is further stored. Depending on the embodiment, the computerized registration system 1 is configured to store the serial number in association with the watch component registration code in the memory of the computerized registration system 1.

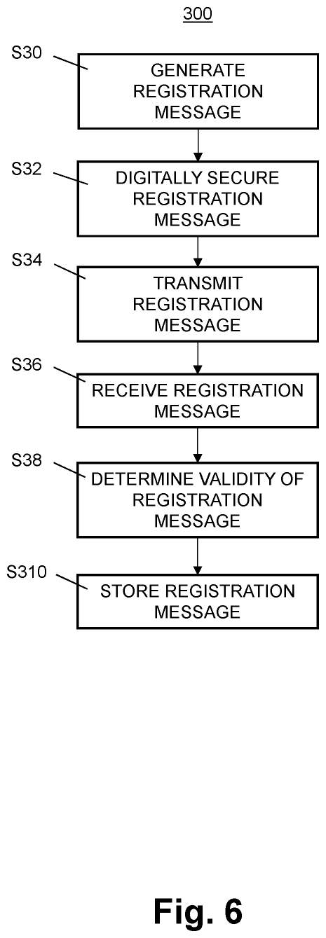

Additionally or alternatively, the computerized registration system 1 is configured to generate a watch component registration message for transmission to a watch component data storage system 5, as is explained below in more detail with reference to FIG. 6.

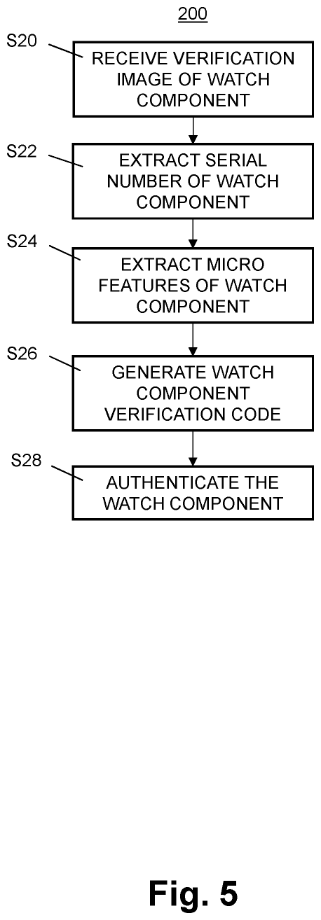

FIG. 5 shows a flow diagram illustrating a method 200 for verification of a watch component. The method 200 is performed by the computerized verification system 2. The method comprises a number of steps S20-S28. The method 200 may be performed on user demand by the computerized verification system 2, or may be performed as part of an existing process related to processing, storing, distributing, handling, managing, checking, or otherwise interacting with watch components built in already sold watches. The method 200 may be performed, for example, at a point-of-sale controlled by a concessionaire. The method 200 may include optional preparatory, intermediary, or subsequent steps as described herein. The method 200 includes a number of steps which are analogous to steps of the method 100 and analogous considerations apply.

In an optional preparatory step, the verification camera device 4 records one or more images of the watch component W′ for verification. The recording of the one or more verification images by the verification camera device 4 may be prompted or initiated by a user, in particular by a user interaction with the verification camera device 4. For example, the user may take an image (e.g., a photograph) of the watch component using a smart phone. Alternatively, the verification camera device 4 may perform the recording of the verification image(s) as part of an automated process, for example when (re)selling the watch component W on the market or when the watch component or the watch which the watch component is belonging to is returned for repair or maintenance and/or when the watch component is assessed for wear and tear.

The verification camera device 4 then transmits the one or more images to the computerized verification system 2. Optionally, the verification camera device 4 transmits metadata related to the one or more images, related to the verification camera device 4 and/or related to circumstances of the recording of the images (e.g., a geographic location and/or a time-point of the verification t1). The metadata may include a hardware configuration information of the verification camera device 4, in particular information related to the camera. For example, a camera model, make, and/or identifier may be included. For example, the specifications of the camera may be included, such as the resolution, the focal distance, and/or the aperture, etc. Additionally, information related to a verification camera device model and/or manufacturer, etc. may be included. Information which uniquely identifies the verification camera device 4 may be included, such as a serial number, MAC address, and/or a mobile subscriber identifier such as the International Mobile Equipment Identity (IMEI) identifier included in a sim card of the verification camera device 4, etc.

The metadata may include software configuration information of the verification camera device 4, such as a current application version of a camera software, a version of an operating system, and/or a firmware version. The metadata may include carrier information related to a mobile radio network to which the verification camera device 4 (for example implemented as a smart phone) is connected, including a cell-ID, a received signal strength indicator, and/or one or more cellular towers to which the verification camera device 4 is connected etc. The metadata may include the SSIDs of WiFi networks in communicative range. The metadata may include diagnostics information of the software and/or hardware.

Optionally, the metadata may include user information of a user of the verification camera device 4, such as a name, telephone number, home address, work address, e-mail, and/or birthdate, etc. Contact information of the user may also be included, such as a list of contacts (name, telephone number of the contacts, and/or further information which identifies the contacts).

The metadata may include a current time-stamp, indicative of a time-point t1 of the verification. The metadata may further include location information of the verification camera device 4, such as a geographic location determined using a global satellite navigation system (GNSS) receiver of the verification camera device 4.

The metadata may include information related to previous watch components W, W′ which verification camera device 4 has imaged, in particular the serial numbers, watch component verification code, time-points, and metadata associated with the previous watch components.

In step S20, the computerized verification system 2 receives the one or more verification images from the verification camera device 4.

Optionally, the computerized verification system 2 checks whether the one or more verification images corresponds to one of a set of allowed watch component types. For example, the computerized verification system 2 checks whether the watch component depicted in the one or more verification images are of a correct defined type or model range.

In step S22, the computerized verification system 2 extracts the serial number from the one or more verification images. The computerized verification system 2 is configured to use optical character recognition (OCR) to extract the serial number.

In an embodiment, the computerized verification system 2 identifies a type of watch component W′ using the one or more verification images.

In an embodiment, the computerized verification system 2 verifies the integrity of the extracted serial number, for example by computing a checksum of the serial number and comparing it with a check digit. Computing the checksum may include making use of the identified type of watch component. Additionally or alternatively, the computerized verification system 2 may verify the validity of the serial number by performing a look-up in database, for example, the watch component data storage system 5, which database includes serial numbers of watch components already built in sold watches. In step S24, the computerized verification system 2 extracts micro features of the watch component from the one or more verification images.

In an embodiment, the computerized verification system 2 is configured to crop the one or more verification images received from the verification camera device 4, for example by cropping the verification image(s) such that only a bounding box (e.g., a rectangular section) of the image(s) including the serial number and a defined border remains. In an example where a given surface element of the watch component W′ includes the serial number twice, the computerized verification system 2 may be configured to generate two cropped images of the watch component W′, a first cropped image including a first instance of the serial number and a second cropped image including a second instance of the serial number.

In an embodiment where the watch component W′ has two copies of the serial number, the computerized verification system 2 is configured to extract micro features from within a bounding box surrounding a particular defined copy of the serial number. Alternatively, the computerized verification system 2 is configured to extract micro features from within two bounding boxes, each bounding box associated with a particular copy of the serial number.

In step S26, the computerized verification system 2 generates a watch component verification code using the extracted micro features and/or the one or more images and the one-way function as described herein. Specifically, the one-way function receives the micro features and/or the one or more images as inputs and generates, as an output, the watch component registration code. The watch component verification code is, for example, an L-dimensional vector or an alphanumeric string.

In step S28, the computerized verification system 2 authenticates the watch component W′ by determining whether the stored watch component registration code associated with the watch component W of the same serial number matches the watch component verification code. In particular, the computerized verification system 2 may determine a correspondence value indicative of a level of correspondence between the watch component registration code and the watch component verification code. The correspondence value may be determined using a correspondence function.

In an embodiment, the computerized verification system 2 authenticates the watch component W′ in cooperation with the watch component data storage system 5. For example, the computerized verification system 2 may send a query message to the watch component data storage system 5 which includes the extracted serial number of the watch component W′. The watch component data storage system 5 performs a look-up and returns, in response to the query message, the watch component registration code associated with the serial number. The query message may further include the watch component type. In another example, the query message may include the watch component verification code itself, with the watch component data storage system 5 performing the authentication as described herein.

The correspondence function may include computing, for example, using a metric (e.g., a Euclidean distance) between the L-dimensional vector representation of the watch component registration code and the L-dimensional vector representation of the watch component verification code. In particular, the correspondence function receives as an input the L-dimensional vector representation of the watch component verification code and the L-dimensional vector representation of the watch component registration code and generates an output correspondence value.

The correspondence value may be a continuous value, such as calculated by a metric, or the correspondence value may be a binary value, for example when the watch component codes are generated using a locality preserving hashing function with appropriate binning of hash values, in which case the correspondence function may include determining whether the watch component registration code and the watch component verification code are in the same bin.

The greater the correspondence value, the greater the micro features of the watch component W correspond or match the micro features of the watch component W′. Above a particular pre-defined correspondence threshold, the chance that the watch component W′ is not the same as the watch component W (i.e. that the watch component W′ is a counterfeit) becomes negligibly small. Corresponding or matching micro features between the watch component W and the watch component W′ means, for example, that at least some of the micro features present in watch component W are also present in watch component W′. In other words, the watch component W has a set M of micro features and the watch component W′ has a set S of micro features, wherein S is a subset of M. The correspondence threshold may be defined, for example, as an absolute and/or relative size of the subset S of micro features present in the watch component W′ with respect to the set M of micro features present in the watch component W.

Depending on the embodiment, matching techniques such as approximate matching, e.g. fuzzy matching, or pattern matching, may be used. For example, the micro features of the watch component W and the micro features of the watch component W′ may each be represented as vectors in a vector space. A metric may be calculated in which a distance between the vectors is computed, the distance being the correspondence value, and a maximum distance still being recognized as a match being the correspondence threshold. For example, the result of the approximate matching may be expressed as a probability of the two watch component W, W′ being one and the same.

Additionally and/or alternatively, corresponding or matching micro features includes defining a particular correspondence for each micro feature individually, and determining an overall correspondence of the watch component W′ with the watch component W using an aggregated measure of correspondence based on the particular correspondence for each micro feature individually. The computerized verification system 2 authenticates the watch component W′, for example, depending on the correspondence value satisfying a pre-determined correspondence threshold. Depending on the correspondence function used, this may be expressed as a minimal distance between the L-dimensional vectors.

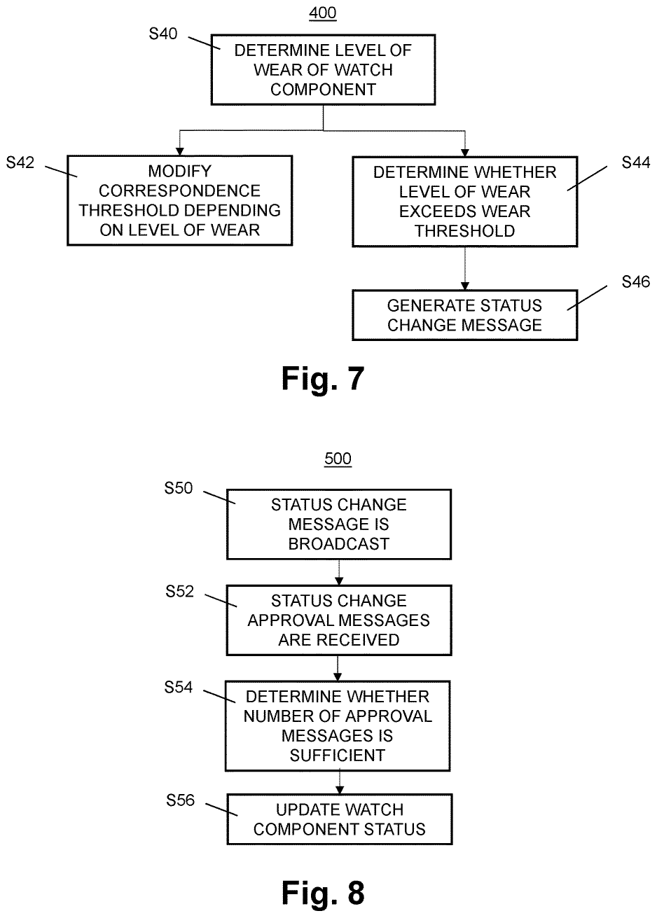

The pre-determined correspondence threshold may depend on the watch component type. The pre-determined correspondence threshold may depend on a time difference between a time-point to of registration of the watch component W and a time-point t1 of verification of the watch component W′. In particular, if the time difference is greater, the pre-determined correspondence threshold may be lower, such that the watch component W′ is still affirmatively authenticated even if the correspondence value is lower than it would be for a smaller time difference. This may be used to account for wear of the watch component. The wear of the watch component may also be taken into account according to steps of the method 400, described below with reference to FIG. 7.

The one-way function is configured such that, even if a defined proportion of the micro features which were extracted during registration of the watch component W as part of the method 100 are no longer extractable, visible, and/or identifiable, for example due to wear, that the watch component verification code generated from the remaining micro features is still similar to the watch component registration code. In other words, even with only a subset of the original micro features still present on the watch component W, the watch component W′ may still be authenticated. In particular, this is possible because of the constraint that the serial numbers between the watch component W during registration and the watch component W′ during verification must match. In an optional step, the computerized verification system 2 generates a message indicating whether the watch component W′ is authentic. The message may be displayed to a user, i.e. a person who initiated the method 200, using a display device of the computerized verification system 2. The user may be made aware of affirmative authentication by means such as a vibration, a sound signal, or a visual indicator generated by the computerized verification system 2.

The message may alternatively be transmitted to another device, for example to the verification camera device 4, where it may also be displayed to the user. As above, the user may be made aware of affirmative authentication by means such as a vibration, a sound signal, or a visual indicator generated by the verification camera device 4. The message may also be stored, for example in the watch component data storage system 5. The message may include the watch component verification code and may include the metadata of the verification camera device 4. In an optional step, the computerized verification system 2 generate and transmits to the watch component data storage system 5, a watch component verification message comprising the watch component verification code and the serial number. The watch component verification message may be digitally secured in a manner analogous to that of the watch component registration message as is described herein in method 300. The watch component verification message may include the correspondence value and metadata related to the verification, for example metadata of the verification camera device 4.

The watch component data storage system 5 stores the watch component verification code in association with the serial number, for example as a log entry related to the watch component W. Optionally, the watch component registration code may be updated using the watch component verification code.

FIG. 6 shows a flow diagram illustrating a method 300 for storage of a watch component registration code. The method 300 is performed, for example, during registration of the watch component W. The method 300 may be performed by the computerized registration system 1. The method includes steps S30-S310.

In step S30, the computerized registration system 1 generates a watch component registration message. The watch component registration message includes the serial number of the watch component W and the watch component registration code of the watch component. The watch component registration message may further include metadata of the computerized registration system 1, metadata of the registration camera 3, metadata related to the watch component (e.g., type, model, model number, fabrication date, fabrication place, material), and/or metadata related to the circumstances of the watch component registration process, including, for example, a time-stamp and/or a geographic location.

In step S32, the watch component registration message is digitally secured by the computerized registration system 1. Digitally securing the watch component registration message allows for verification of the watch component registration message, for example to enable a recipient of the watch component registration message to confirm that the watch component registration message is legitimate and was generated by the computerized registration system 1. Digitally securing the watch component registration message may further prevent tampering with or alteration of the watch component registration message. Digitally securing the watch component registration message may further prevent reading of the watch component registration message while the watch component registration message is in transit or in temporary storage.

The watch component registration message may be secured by the computerized registration system 1 digitally signing the watch component registration message, which may involve creating a digital signature using a private key of the computerized registration system 1. Digitally signing the watch component registration message may further include hashing the watch component registration message and including a hash of the watch component registration message as part of the digital signature and/or by other known methods. The digital signature is provided with, or as part of, the watch component registration message.

The watch component registration message may, alternatively or additionally, be encrypted, for example using symmetric encryption or using public/private key encryption, for example by encrypting the watch component registration message using a public key of an intended recipient, in particular the watch component data storage system 5.

In step S34, the watch component registration message is transmitted, by the computerized registration system 1, to the watch component data storage system 5. The transmission may further be secured, for example by establishing a virtual private network (VPN) between the computerized registration system and the watch component data storage system 5, or by use of a dedicated communications line.

In step S36, the watch component registration message is received in the watch component data storage system 5.

In step S38, the watch component data storage system 5 determines the validity of the watch component registration message, for example by determining whether the digital signature is authentic, or by successfully decrypting the watch component registration message. The watch component data storage system 5 may use a public key of the watch component data storage system 5, or a public key of the computerized registration system 1, to perform the determination of validity.

In step S310, the watch component registration message, in particular the contents of the message including the serial number and the watch component registration code, are stored in the watch component data storage system 5.

FIG. 7 shows a flow diagram illustrating a method 400 for determining a level of wear of a watch component and performing one or more further steps. The method 400 may be performed by the computerized verification system 2. The method 400 may, alternatively or additionally, be performed at least in part by the watch component data storage system 5. The method 400 may be performed during, or subsequent to, the method 200 for authenticating the watch component W′. The method 400 comprises a number of steps S40-S46, at least some of which are optional.

In step S40, the level of wear of the watch component W′ is determined. The level of wear is determined using the one or more verification images and computerized image analysis.

The determination of the level of wear may take into consideration an age of the watch component W′, in particular a time difference between the current time-point (e.g., the verification time-point t1), and the registration time-point t0. The determination of the level of wear may take into account the watch component type. The determination of the level of wear may use a representation (e.g., one or more images or a model) of a new watch component of the same type as the watch component W′, in particular as a basis of comparison.

In an embodiment where approximate pattern matching is used to compare the micro features of the watch component W at the time-point to with the micro features of the watch component W′ at the time-point t1, the degree of pattern matching may be used to determine the level of wear. In this case, the degree of pattern matching is the correspondence value. The level of wear may also be expressed as a probability, expressed as a probability value, of the two watch components W, W′ being the same. A predetermined wear threshold may be defined as a particular probability value.

Further, where the micro features of the watch component W at the time-point to and the micro features of the watch component W′ at the time-point t1 are expressed as vectors in a vector space, the correspondence value may be defined as being inversely related to a distance between the vectors, the distance calculated using a metric. Thereby, a greater distance would correspond to a lesser correspondence value and the level of wear thus determined. If a minimum defined distance is exceeded, then the wear threshold is considered to be exceeded. In an embodiment, the number of micro features in the watch component W′ (as present in the verification images and/or represented by the watch component verification code) is used to determine the level of wear. For example, the number of micro features may be compared to an absolute minimum threshold to determine whether the wear threshold has been exceeded, or not. Also, the number of micro features in the watch component W′ as compared to the number of micro features present in the watch component W (as represented by the watch component registration code) may be used to determine the level of wear. For example, the proportion of micro features in the watch component W as compared with the number of micro features in the watch component W′ may be used to determine the level of wear.

The image analysis may comprise determining a level of contrast in the one or more verification images, and comparing the level of contrast to a baseline contrast. The image analysis may comprise determining a level of sharpness in the one or more verification images, and comparing the level of sharpness to a baseline sharpness. The image analysis may comprise determining one or more colors in the one or more images and determining the colors to one or more baseline colors. Additional aspects of the image may also be considered, in particular line definition, such as the line definition of the serial number. The baselines, for example of the contrast, sharpness, and/or colors are defined using the representation of the new watch component.

In step S42, the correspondence threshold is modified depending on the level of wear determined. In particular, the correspondence threshold may be lowered in accordance with the level of wear, such that a relatively higher level of wear leads to a relatively greater lowering of the correspondence threshold. This ensures that even a worn watch component W′ which may have been in use for some years, may still be affirmatively authenticated.

In an embodiment, the level of wear is included in the watch component verification message transmitted to the watch component data storage system 5.

In step S44, it is determined whether the level of wear exceeds a pre-defined wear threshold, indicative of a watch component W′ which is for example to be replaced at the next maintenance event. This step may be performed by the computerized verification system 2 and/or the watch component data storage system 5. The determination of whether the level of wear exceeds the pre-defined wear threshold may be transmitted to the watch component data storage system 5, for example if the determination was performed in the computerized verification system 2.

In step S46, the computerized verification system 2 and/or the watch component data storage system 5 generates a status change message upon positive determination that the level of wear exceeds the pre-defined wear threshold. The status change message indicates for example that the watch component W′ is to be replaced at upcoming maintenance. For example, the status change message includes the serial number of the watch component W′ and optionally also includes the level of wear. The status change message, if generated by the computerized verification system 2, may be transmitted to the watch component data storage system 5 which receives the status change message. The watch component data storage system 5 is configured to update the status of the watch component W′ according to the status change message, for example by changing the status of the watch component W′ to “to be replaced” or the like. The watch component W′ is then, at an appropriate time point, recalled for maintenance, for example the next time that the watch component W′ is processed by a facility affiliated with a service center or similar institution tasked with servicing and/or repairing and when appropriate, recalling watches by notification to the owner.

FIG. 8 shows a flow diagram illustrating a method 500 for updating a status of a watch component W, W′. The method 500 may be performed, at least in part, by the computerized verification system 2 and/or the watch component data storage system 5. The method 500 may be performed whenever a status change message related to the watch component W is generated. The status change message may relate to a status change request, requesting that the status of one or more watch components W is changed from a particular status to another status, for example from “to be replaced” to “retired”, from “to be updated” to “updated”, etc. In order to ensure that this process takes place in a secure manner, the described method 500 is performed. The method 500 includes a number of steps S50-S56.

In step S50, a status change message is generated. The status change message is a proposal, by a given entity, to change the current status of one or more watch components including the watch component W, W′, from one status to another. As such, the status change message identifies at least the particular watch component W, W′, for example by including a serial number or a serial number range, and indicates at least a new desired status of the watch component W, W′. The entity may be one of the entities described as part of the electronic system S, for example the computerized registration system 1, the computerized verification system 2, and/or the watch component data storage system 5. The entity may, however, be another computerized entity communicatively coupled to the electronic system S, for example a computerized device authorized and/or controlled by the manufacturer.

The status change message is broadcast, i.e., transmitted, to a plurality of authorization entities. The authorization entities are, for example, each authorized and/or controlled by the manufacturer. The authorization entities may be, for example, a number of outlets of the manufacturer in a country or even worldwide. The authorization entities may also include facilities for checking or repair or otherwise handling watch components W, W′.

In step S52, the status change message is received by at least a subset of the authorization entities. The subset of authorization entities validates and approves the status change message and generate and transmit approval messages in response to the status change message. The approval messages are indicative of approval of the status change related to the watch components identified in the status change message. The approval messages may be digitally secured messages as described herein.

The approval messages are received by the entity which generated the status change message. Alternatively or additionally, the approval messages are transmitted to the watch component data storage system 5, which receives the approval messages.

In step S54, it is determined, for example by the receiving entity and/or by the watch component data storage system 5, whether the number of received approval messages is sufficient. For example, a particular proportion of the authorization entities may be required to have transmitted approval messages, or at least a pre-defined number of authorization entities may be required to have transmitted the approval messages. The approval messages may also be validated, i.e. checked for authenticity.

In step S56, the status of the watch component W, W′ is updated in the watch component data storage system 5 according to the proposed new status included in the status update message. The above-described embodiments of the disclosure are exemplary and the person skilled in the art knows that at least some of the components and/or steps described in the embodiments above may be rearranged, omitted, or introduced into other embodiments without deviating from the scope of the present disclosure.

1-18. (canceled)

19. A computer-implemented method for registration of a watch component, the method comprising:
receiving, in a computerized registration system, from a registration camera, an image of a watch component, the image comprising a serial number of the watch component;
extracting, in the computerized registration system, the serial number of the watch component from the image, using optical character recognition;
extracting, in the computerized registration system, micro features of the watch component from the image;
generating, in the computerized registration system, a watch component registration code by processing the micro features using a one-way function; and
storing the serial number in association with the watch component registration code.

20. The method according to claim 19, further comprising:
generating, in the computerized registration system, a watch component registration message comprising the serial number and the watch component registration code;
digitally securing, by the computerized registration system, the watch component registration message by comprising, in the watch component registration message, a digital signature generated in the computerized registration system and additionally or alternatively by way of encrypting contents of the watch component registration message using a secret key of the computerized registration system;
and wherein storing the serial number in association with the watch component registration code comprises:
transmitting, from the computerized registration system to a watch component data storage system, the digitally secured watch component registration message;
receiving, in the watch component data storage system, the digitally secured watch component registration message;
determining, in the watch component data storage system, whether the digitally secured watch component registration message is authentic by validating the digital signature and additionally or alternatively by successful decryption of the watch component registration message; and
storing, in the watch component data storage system, the serial number in association with the watch component registration code dependent on affirmative authentication of the watch component registration message.

21. The method according to claim 20, further comprising:
transmitting, from a computerized authorization system to the watch component data storage system, a status change message comprising the serial number of the watch component and an updated status of the watch component, the updated status comprising one or more of the following watch component statuses: registered, in stock, to be replaced, to be updated, to be upgraded, to be destroyed flagged for servicing or exchange or repair, retired or destroyed; and
updating, in the watch component data storage system, a status of the watch component according to the updated status.

22. The method according to claim 21, wherein the status change message comprises a plurality of a digital signatures from a plurality of authorization entities, and updating the status of the watch component is dependent on the computerized authorization system affirmatively verifying the confirmations.

23. The method according to claim 19, wherein the method further comprises:
receiving, in a computerized verification system, from a verification camera device, a verification image of the watch component, the verification image comprising the serial number of the watch component;
extracting, in the computerized verification system, the serial number of the watch component from the verification image, using optical character recognition;
extracting, in the computerized verification system, micro features of the watch component from the verification image;
generating, in the computerized verification system, a watch component verification code by processing the micro features using the one-way function;
authenticating the watch component, in the computerized verification system, if the watch component verification code matches the stored watch component registration code for the watch component with the serial number.

24. The method according to claim 23, wherein authenticating the watch component comprises:
calculating, in the computerized verification system, using a correspondence function, a correspondence value between the watch component verification code and the watch component registration code, the correspondence value indicative of a degree of correspondence; and
authenticating, in the computerized verification system, the watch component if the correspondence value satisfies a pre-defined correspondence threshold.

25. The method according to claim 24, wherein authenticating the watch component further comprises:
analyzing, in the computerized verification system, using image analysis, the verification image to determine a level of wear of the watch component; and
modifying, in the computerized verification system, the pre-defined correspondence threshold depending on the level of wear of the watch component.

26. The method according to claim 23, further comprising:
analyzing, in the computerized verification system, using image analysis, the verification image to determine a level of wear of the watch component;
determining, in the computerized verification system, whether the level of wear exceeds a pre-defined wear threshold; and
generating, in the computerized verification system, a status change message comprising the serial number of the watch component and an updated status of the watch component, the updated status indicating that the watch component has been flagged for servicing or exchange or repair, upon the level of wear exceeding the pre-defined wear threshold.

27. The method according to claim 19, comprising
generating a cropped image of the watch component which comprises the serial number and a pre-defined margin around a bounding box of the serial number, and
extracting the micro features of the watch component from the cropped image.

28. The method according to claim 19, wherein the micro features of the watch component comprise inhomogeneities of the watch component substrate and/or features caused by irreproducible randomness in a manufacturing process of the watch component.

29. The method according to claim 28, wherein the micro features of the watch component are at least partially the result of a cutting and/or engraving process, in particular a cutting and/or engraving process which comprises cutting and/or engraving of the serial number.

30. The method according to claim 19, further comprising receiving, in the computerized verification system, metadata from the verification camera device, the metadata comprising one or more of the following: hardware configuration information of the verification camera device, in particular information related to the camera, software configuration information of the verification camera device, user information of a user of the verification camera device, contact information of the verification camera device, diagnostics data of the verification camera device, a current time-stamp, location information of the verification camera device, or information related to previous watch components the verification camera device has imaged.

31. The method according to claim 30, further comprising:
recording, in the computerized verification system, a status log associated with the watch component, the status log comprising a plurality of log entries, each entry comprising the watch component verification code and the metadata from the verifying camera device.

32. The method according to claim 19, further comprising:
transmitting, from a computerized authorization system to the watch component data storage system, a status change message comprising the serial number of the watch component and an updated status of the watch component, the updated status comprising one or more of the following watch component statuses: registered, in stock, to be replaced, to be updated, to be upgraded, to be destroyed flagged for servicing or exchange or repair, retired or destroyed; and
updating, in the watch component data storage system, a status of the watch component according to the updated status.

33. The method according to claim 32, wherein the status change message comprises a plurality of a digital signatures from a plurality of authorization entities, and updating the status of the watch component is dependent on the computerized authorization system affirmatively verifying the confirmations.

34. A computerized registration system for registration of a watch component, the computerized registration system comprising a processing unit configured to:
receive, from a registration camera, an image of a watch component, the image comprising a serial number of the watch component;
extract the serial number of the watch component from the image, using optical character recognition;
extract micro features of the watch component from the image;
generate a watch component registration code by processing the micro features using a one-way function; and
store the watch component registration code in association with the serial number of the watch component.

35. A computerized verification system for verification of a watch component, the computerized verification system comprising a processing unit configured to:
receive, from a verification camera device, a verification image of a watch component, the verification image comprising a serial number of the watch component;
extract the serial number of the watch component from the verification image, using optical character recognition;
extract micro features of the watch component from the verification image;
generate a watch component verification code by processing the micro features using a one-way function; and
authenticate the watch component, if the watch component verification code matches a watch component registration code, stored in a watch component data storage system for the serial number of the watch component.

36. A computer program product for registration of a watch component comprising computer program code configured to control a processing unit such that the processing unit performs the steps of:
receiving, from a camera, an image of a watch component, the image comprising a serial number of the watch component;
extracting the serial number of the watch component from the image, using optical character recognition;
extracting micro features of the watch component from the image;
generating a watch component registration code by processing the micro features using a one-way function; and
storing the watch component registration code in association with the serial number of the watch component.

37. A computer program product for verification of a watch component comprising computer program code configured to control a processing unit such that the processing unit performs the steps of:
receiving, from a verification camera device, a verification image of a watch component, the verification image comprising a serial number of the watch component;
extracting the serial number of the watch component from the verification image, using optical character recognition;
extracting micro features of the watch component from the verification image;
generating a watch component verification code by processing the micro features using the one-way function; and
authenticating the watch component, if the watch component verification code matches a watch component registration code, stored in a watch component data storage system for the serial number of the watch component.
